(19) United States
(12) Patent Application Publication
(10) Pub. No.: US 2008/0208535 A1
(43) Pub. Date: Aug. 28, 2008

(54) DISC ARRAY DEVICE

(75) Inventor: RYO SUZUKI, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 12/032,125

(22) Filed: Feb. 15, 2008

(30) Foreign Application Priority Data
Feb. 23, 2007 (JP) 2007-044109

(51) Int. Cl. G21C 17/00

(52) U.S. Cl. 702/184

(57) ABSTRACT

The present invention aims to provide a disc array device capable of efficiently managing the replacement time of a battery backup unit of the disc array device. Installed environment information and operation state information of a battery backup unit of a disc array device are acquired in the disc array device. If the installed environment is determined as not appropriate from such information, the inappropriateness of the installed environment is notified to the user. If the operation state is not appropriate, the inappropriateness of the operation state is notified to the user. Furthermore, the lifetime of the battery backup unit is predicted and the replacement period is notified to the user.

### CROSS-REFERENCE TO RELATED APPLICATION

This application is based upon and claims the benefit of priority from Japanese patent application No. 2007-044109, filed on Feb. 23, 2007, the disclosure of which is incorporated herein in its entirety by reference.

### BACKGROUND OF THE INVENTION

1. Field of the Invention

The present invention relates to a disc array device having a function of notifying the lifetime of a battery backup unit and a disc controller control program.

2. Related Art

Generally, a period set by the battery manufacturer is used for determining the lifetime of the battery backup unit of the disc array device, and the user determines the replacement time of the battery backup unit based on the period. However, since the operation state and the installed environment of the battery backup unit which affect on the lifetime is not taken into consideration, there has been such disadvantages that the battery backup unit which is still in the usable state gets replaced at an early stage, or, the battery backup unit is continuously used beyond the durable limit and the reliability of the disc array device lowers.

As the technique in the similar field, a battery control device for displaying a warning of the charge/discharge state of the battery is disclosed in a paragraph 0013 of Japanese Laid-Open Patent Publication No. 2001-136666 (patent document 1), but it displays merely the charge/discharge state of the battery for each time, and there is no warning displayed about the lifetime (durable limit) of the battery itself.

Further, a lifetime predicting device which calculates the degradation speed of the rechargeable battery based on the fluctuation in average temperature, average current value, and storage amount of the rechargeable battery, and also calculates the lifetime of the rechargeable battery from the relationship between the tolerable degradation amount and the degradation speed is proposed in paragraphs 0022-0032 of Japanese Laid-Open Patent Publication No. 2003-297435 (patent document 2), but it predicts the lifetime of the rechargeable battery based on the physical fluctuations only which appear in the rechargeable battery, as a result, and the operation state of the rechargeable battery is not taken into consideration.

### SUMMARY OF THE INVENTION

It is an exemplary object of the present invention to provide particularly a disc array device and a disc controller control program capable of preventing such disadvantages that the battery backup unit which is still in the usable state gets replaced at an early stage, or, the battery backup unit is continuously used beyond the durable limit and the reliability of the disc array device lowers, by notifying the lifetime of the battery backup unit based on the operation state of the battery backup unit.

To achieve the above exemplary object, a disc array device according to an exemplary aspect of invention relates to a disc array device including a disc unit for storing data, a disc controller for controlling input/output of data between the disc unit and a high-level device, and a battery backup unit for supplying backup power to the disc unit and the disc controller. The disc array device includes an operation state detecting device for detecting an operation state of the battery backup unit; an operation reference lifetime element calculating device for calculating a lifetime element of the battery backup unit based on the operation state detected by the operation state detecting device; and an operation reference lifetime calculating device for calculating a lifetime of the battery backup unit based on the lifetime element calculated by the operation reference lifetime element calculating device.

A battery backup drive controlling method according to another exemplary aspect of invention relates to a battery backup drive controlling method for supplying a backup power by drive controlling a battery backup unit; the method including the steps of detecting an operation state of the battery backup unit; calculating a lifetime element of the battery backup unit based on the detected operation state; and calculating a lifetime of the battery backup unit based on the calculated lifetime element.

A disc controller control program according to still another exemplary aspect of invention relates to a disc controller control program for causing a microprocessor arranged in a disc controller of a disc array device to execute functions of detecting an operation state of the battery backup unit; calculating a lifetime element of the battery backup unit based on the detected operation state; and calculating a lifetime of the battery backup unit based on the calculated lifetime element.

As an exemplary advantage according to the invention, the present invention detects the operation state of the battery backup unit, that is, the operation state information reflecting the usage manner of the battery backup unit, obtains the lifetime element of the battery backup unit dependent on each operation state information, and estimates the final lifetime of the battery backup unit by taking the lifetime elements into consideration, and thus the estimation of the lifetime of the battery backup unit becomes accurate, and, such disadvantages that the battery backup unit which is still in the usable state gets replaced at an early stage, or, the battery backup unit is continuously used beyond the durable limit and the reliability of the disc array device lowers can be prevented in advance.

### BRIEF DESCRIPTION OF THE DRAWINGS

FIG. 1 is a conceptual view showing, in a simplified manner, one example of a network system configured including a disc array device installed with a disc controller control program applied with the present invention;

FIG. 2 is a functional block diagram showing the outline of the configuration of the disc array device;

FIG. 3 is a flowchart showing an outline of a disc controller control program;

FIG. 4 is a sequence chart showing the operation of the disc array device and the battery backup unit; and

FIG. 5 is a view schematically showing a matrix used in calculating a lifetime of the battery backup unit based on the lifetime element dependent on the installed environment and the lifetime element dependent on the operation state.

### DETAILED DESCRIPTION OF THE EXEMPLARY EMBODIMENTS

The exemplary embodiments for implementing the invention will now be specifically described with reference to the drawings.

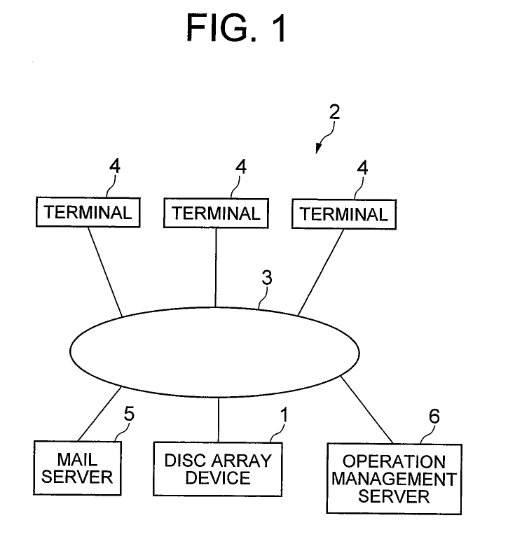

FIG. 1 is a conceptual view showing, in a simplified manner, one example of a network system configured including a disc array device 1 installed with a disc controller control program, to which the present invention is applied.

The network system 2 is schematically configured by the disc array device 1, a plurality of computer terminals 4 using the disc array device 1 via the network 3 such as intranet, a mail server 5 for performing transfer process etc. of an e-mail on the network 3, and an operation management server 6 for entirely managing the network system 2 by acquiring fault information and setting information of the equipment from the disc array device 1, each computer terminal 4, and the mail server 5 via the network 3. Each computer terminal 4 and the operation management server 6 are high-level devices when seen from the disc array device 1.

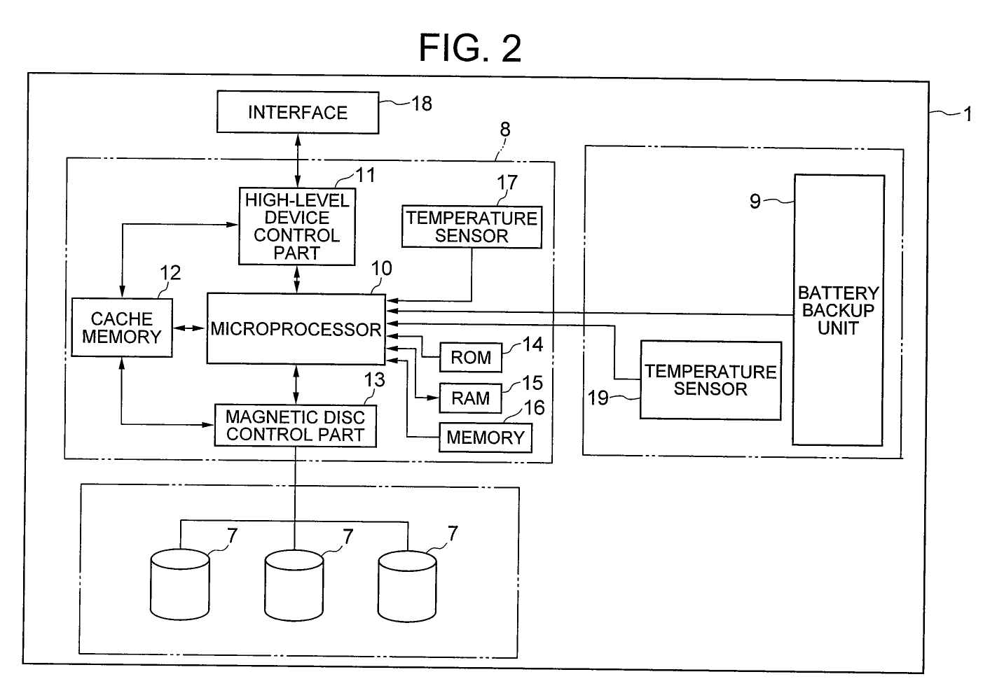

The outline of the configuration of the disc array device 1 is shown in a functional block diagram of FIG. 2.

The main section of the disc array device 1 is configured by a plurality of disc units 7 for storing data, a disc controller 8 for controlling input/output of data between the high-level device such as the computer terminal 4 and the operation management server 6 and the disc unit 7, and a battery backup unit 9 for supplying backup power to a driving part of the disc unit 7 and the disc controller 8.

The disc controller 8 includes a microprocessor 10 serving as a control part, a high-level device control part 11, a cache memory 12, and a magnetic disc control part 13, and furthermore, a ROM 14 for storing the disc controller control program, a RAM 15 for temporarily storing the computation processing data, a non-volatile memory 16 for storing abnormality etc. of the battery backup unit 9 in addition to various functions and parameters, and a temperature sensor 17 made up of thermocouple etc. for detecting the temperature of the disc controller 8.

The high-level device control part 11 is connected to the high-level device such as the computer terminal 4 and the operation management server 6 via an interface 18 and the network 3, and is provided to control the input/output of data between the disc controller 8 and the high-level device.

The magnetic disc control part 13 is connected to the disc unit 7 made up of magnetic disc device, and is provided to control the input/output of data between the disc controller 8 and the disc unit 7.

The cache memory 12 temporarily stores the write data received from the high-level device such as the computer terminal 4 and the operation management server 6, or the read data read out from the disc unit 7, and is configured by a semiconductor memory etc. enabling high-speed access than the disc unit 7.

Furthermore, a temperature sensor 19 such as thermocouple etc. for detecting the temperature of the battery backup unit 9 itself is arranged on the side of the battery backup unit 9, so that the temperature of the battery backup unit 9 is input to the microprocessor 10 of the disc controller 8.

In addition to the normal disc controller control program necessary in the input/output control of the data between the disc unit 7 and the high-level device such as the computer terminal 4 and the operation management server 6, the ROM 14 is stored with a disc controller control program for causing the microprocessor 10 of the disc controller 8 to serve as an operation state detecting device for detecting the operation state of the battery backup unit 9, an installed environment detecting device for detecting the installed environment of the battery backup unit 9, an operation reference lifetime element calculating device for calculating the lifetime element of the battery backup unit 9 based on the operation state detected by the operation state detecting device, an environment reference lifetime element calculating device for calculating the lifetime element of the battery backup unit 9 based on the installed environment detected by the installed environment detecting device, a lifetime calculating device for calculating the overall lifetime of the battery backup unit 9 based on the lifetime element calculated by the operation reference lifetime element calculating device and the lifetime element calculated by the environment reference lifetime element calculating device, an operation state abnormality detecting device for detecting the abnormality of the operation state of the battery backup unit 9, an installed environment abnormality detecting device for detecting the abnormality of the installed environment of the battery backup unit 9, and a communication control device for outputting the lifetime calculated by the lifetime calculating device and the abnormality detected by the operation state abnormality detecting device and the installed environment abnormality detecting device to the computer terminal 4 and the operation management server 6, which are high-level devices, using the interface 18.

In the exemplary embodiment, the discharging interval and the discharging depth of the battery backup unit 9 are detected as operation state information of the battery backup unit 9, and the temperatures of the disc controller 8 and the battery backup unit 9 are detected using the temperature sensors 17, 19 as installed environment information of the battery backup unit 9.

A function for obtaining the lifetime element dependent on the discharging interval and the discharging depth, which are operation state information reflecting the operation state of the battery backup unit 9, a function for obtaining the lifetime element dependent on the temperature, which is the installed environment information reflecting the installed environment of the battery backup unit 9, and a function for estimating the final lifetime of the battery backup unit 9 by taking into consideration the lifetime elements obtained in the above functions are stored in the ROM 14 in advance.

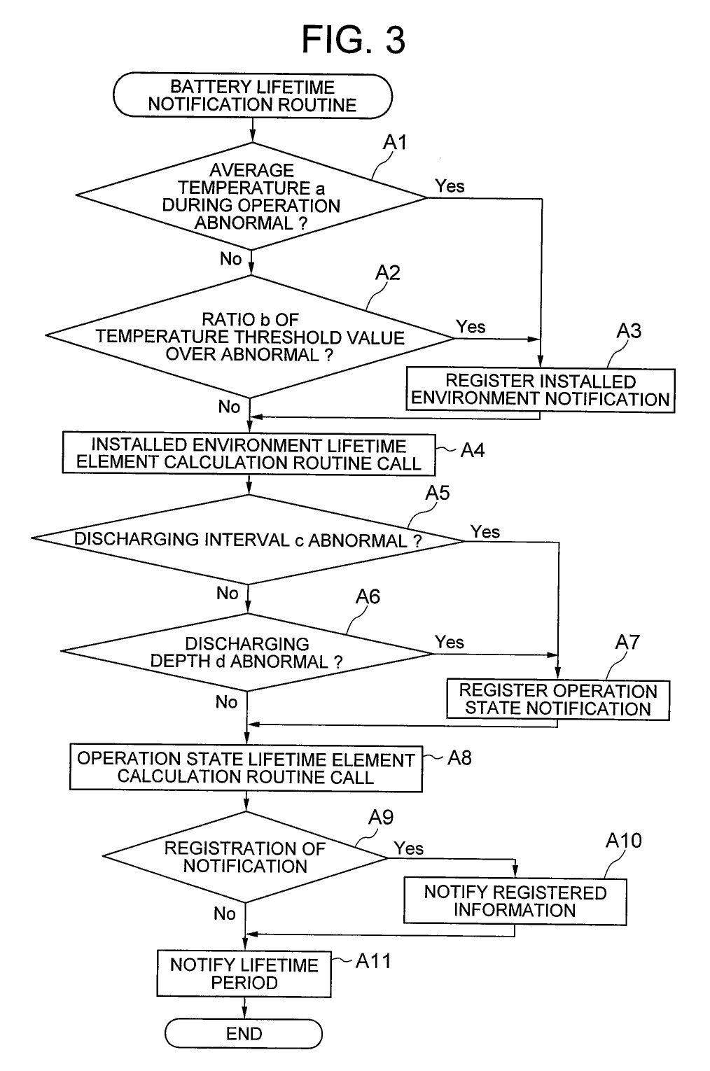

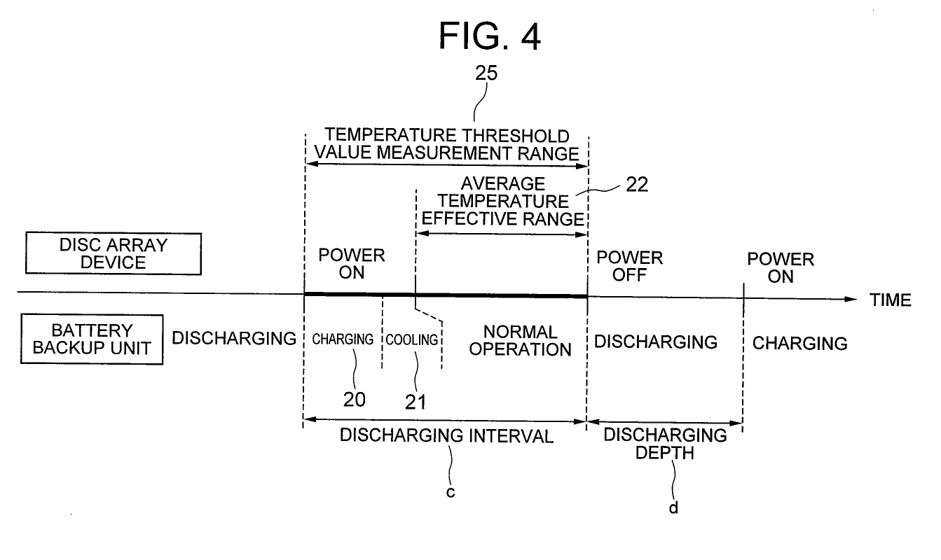

The overall operation of the disc array device 1 of the present exemplary embodiment will be specifically described with reference to the flowchart of FIG. 3 showing the outline of the processing operation of the microprocessor 10 operating according to the disc controller control program of the ROM 14, and the sequence chart of FIG. 4 showing the operation of the disc array device 1 and the battery backup unit 9.

The control on the input/output of the data between the disc controller 8 and the high-level device and the control on the input/output of the data between the disc controller 8 and the disc unit 7 are similar to the general control, and thus only the process of the battery lifetime notifying routine related to the prediction of the lifetime of the battery backup unit 9 and the detection of abnormality will be described herein.

The battery lifetime notifying routine starts the operation simultaneously with the activation of the disc array device 1.

When the disc array device 1 is activated, the microprocessor 10 serving as the installed environment detecting device acquires the temperature information such as the temperature of the disc controller 8 and the temperature of the battery backup unit 9 via the temperature sensors 17, 19 as installed environment information. A case where the temperature information is detected as the installed environment information is described by way of example, but other information reflecting the installed environment of the battery backup unit 9 can be detected as the installed environment information.

The microprocessor 10 serving as the installed environment detecting device then calculates an average temperature “a” while the battery backup unit 9 is operating from the obtained temperature information. The average temperature “a” is obtained by detecting the temperatures of the disc controller 8 and the battery backup unit 9 by way of the temperature sensors 17, 19 at a predetermined sampling period and taking the average thereof over a time zone 22 (see FIG. 4) excluding the charging time 20 of when the disc array device 1 is operating and the cooling period 21 following thereto.

The microprocessor 10 serving as the installed environment abnormality detecting device then determines whether or not the obtained average temperature “a” is deviated, beyond the permissible limit, from the temperature reference value defined in advance (step A1 of FIG. 3).

The microprocessor 10 serving as the installed environment abnormality detecting device stores information which indicates that it is necessary to notify the user that the installed environment of the disc array device 1 is not appropriate in the non-volatile memory 16 only when the average limit “a” is deviated, beyond the permissible limit, from the temperature reference value (step A3 of FIG. 3).

Various types of temperature reference value to be compared are stored according to the type of battery incorporated in the battery backup unit 9 as parameters in the ROM 14 in advance, and the microprocessor 10 serving as the installed environment abnormality detecting device reads out the temperature reference value corresponding to the type of battery from the ROM 14 and performs the determination process of step A3.

The microprocessor 10 serving as the installed environment abnormality detecting device counts the number of samplings at which the temperature detected by the temperature sensor 17, 19 exceeds the temperature threshold value set in advance within the range of a time zone 25 (see FIG. 4) including the charging time 20 of when the disc array device 1 is operating and the cooling period 21 following thereto, obtains the ratio “b” with the number of samplings at which the temperature detected by the temperature sensor 17, 19 does not exceed the temperature threshold value, and determines whether or not the ratio “b” is deviated, beyond the permissible limit, from the ratio reference value set in advance (step A2 of FIG. 3).

The microprocessor 10 serving as the installed environment abnormality detecting device stores information which indicates that it is necessary to notify the user that the installed environment of the disc array device 1 is not appropriate in the non-volatile memory 16 only when the ratio “b” of the number samplings is deviated, beyond the permissible limit, from the ratio reference value (step A3 of FIG. 3).

Similar to the case of the temperature reference value, various types of ratio reference value to be compared are stored according to the type of battery incorporated in the battery backup unit 9 as parameters in the ROM 14 in advance, and the microprocessor 10 serving as the installed environment abnormality detecting device reads out the ratio reference value corresponding to the type of battery from the ROM 14 and performs the determination process of step A2.

The microprocessor 10 serving as the environment reference lifetime element calculating device reads out the installed environment lifetime element calculating routine, that is, the function fₑ (a, b) for obtaining the lifetime element dependent on the temperature information, which is one type of installed environment information reflecting the installed environment of the battery backup unit 9, from the ROM 14, substitutes the average temperature “a” and the ratio “b” of the number of samplings into the installed environment lifetime element calculating routine, and calculates the lifetime element dependent on the temperature (step A4 of FIG. 3).

Similar to the case of the temperature reference value and the ratio reference value, various types of functions fₑ (a,b) for obtaining the lifetime element dependent on the temperature information are stored according to the type of battery incorporated in the battery backup unit 9 in the ROM 14 in advance, and the microprocessor 10 serving as the environment reference lifetime element calculating device reads out the function fₑ (a,b) corresponding to the type of battery from the ROM 14 and calculates the lifetime element in the process of step A4.

When the power supply is disconnected in the disc array device 1 in operation, the microprocessor 10 of the disc controller 8 records whether or not the backup was executed with the built-in battery of the battery backup unit 9, and, when the power is supplied or re-supplied, the microprocessor 10 of the disc controller 8 determines whether or not the battery backup was executed before the power is supplied. When the backup by the built-in battery was executed, that is, when the built-in battery was discharged, the discharged time of the built-in battery is measured with the time measuring device. The time measuring device may be a built-in timer that operates by frequency dividing the clock of the microprocessor 10, or may be an independent timer circuit. If the discharged time is greater than or equal to a defined time, the microprocessor 10 serving as the operation state detecting device stores the discharging interval “c” (see FIG. 4) and the discharging depth “d” (see FIG. 4), and furthermore, the number of discharges of the battery backup unit 9 as operation state information of the battery backup unit 9, that is the operation state information reflecting the usage manner.

The microprocessor 10 serving as the operation state abnormality detecting device determines whether or not the discharging interval “c” is deviated, beyond the permissible limit, from the discharging interval reference value of the battery backup unit 9 (step A5 of FIG. 3).

The microprocessor 10 serving as the operation state abnormality detecting device stores information which indicates that it is necessary to notify the user that the operation state of the disc array device 1 is not appropriate in the non-volatile memory 16 only when the discharging interval “c” is deviated, beyond the permissible limit, from the discharging interval reference value (step A7 of FIG. 3).

Similar to the case of the temperature reference value and the ratio reference value, various types of discharging interval reference value to be compared are stored according to the type of battery incorporated in the battery backup unit 9 as parameters in the ROM 14 in advance, and the microprocessor 10 serving as the operation state abnormality detecting device reads out the discharging interval reference value corresponding to the type of battery from the ROM 14 and performs the determination process of step A5.

The microprocessor 10 serving as the operation state abnormality detecting device determines whether or not the discharging depth “d” is deviated, beyond the permissible limit, from the discharging depth reference value of the battery backup unit 9 (step A6 of FIG. 3).

The microprocessor 10 serving as the operation state abnormality detecting device stores information which indicates that it is necessary to notify the user that the usage manner, that is, the operation state of the disc array device 1 is not appropriate in the non-volatile memory 16 only when the discharging depth “d” is deviated, beyond the permissible limit, from the discharging depth reference value (step A7 of FIG. 3).

Similar to the case of the temperature reference value, the ratio reference value, and the discharging interval reference value, various types of discharging depth reference value to be compared are stored according to the type of battery incorporated in the battery backup unit 9 as parameters in the ROM 14 in advance, and the microprocessor 10 serving as the operation state abnormality detecting device reads out the discharging depth reference value corresponding to the type of battery from the ROM 14 and performs the determination process of step A6.

The microprocessor 10 serving as the operation reference lifetime element calculating device reads out the operation state lifetime element calculating routine, that is, the function fᵤ (c, d) for obtaining the lifetime element dependent on the discharging interval “c” and the discharging depth “d”, which are operation state information reflecting the operation state of the battery backup unit 9, from the ROM 14, substitutes the discharging interval “c” and the discharging depth “d”, which are operation state information, into the operation state lifetime element calculating routine, and calculates the lifetime element dependent on the discharging interval “c” and the discharging depth “d” (step A8 of FIG. 3).

Various types of functions fᵤ (c, d) for obtaining the lifetime element dependent on the discharging interval “c” and the discharging depth “d”, which are operation state information, are stored according to the type of battery incorporated in the battery backup unit 9 in the ROM 14 in advance, and the microprocessor 10 serving as the operation reference lifetime element calculating device reads out the function fᵤ (c, d) corresponding to the type of battery from the ROM 14 and calculates the lifetime element in the process of step A8.

The microprocessor 10 serving as the installed environment abnormality detecting device and the operation state abnormality detecting device determines whether or not information indicating that the installed environment is not appropriate or that the operation state is not appropriate is stored in the non-volatile memory 16 (step A9 of FIG. 3), where if at least one is stored, the microprocessor 10 serving as the communication control device outputs the content of abnormality to the operation management server 6, which is the high-level device, via the interface 18 and the network 3 (step A10 of FIG. 3).

In this case, the values of the average temperature “a” and the ratio “b” of the number of samplings, which are one type of installed environment information, the value of the lifetime element dependent on and temperature information, which is installed environment information, and furthermore, the values of the discharging interval “c” and the discharging depth “d”, which are one type of operation state information, the value of the lifetime element dependent on the discharging interval and the discharging depth, which are the operation state information, and the like may be output together.

The operation management server 6 displays the contents thereof on the attached display device etc., and stores the same as log.

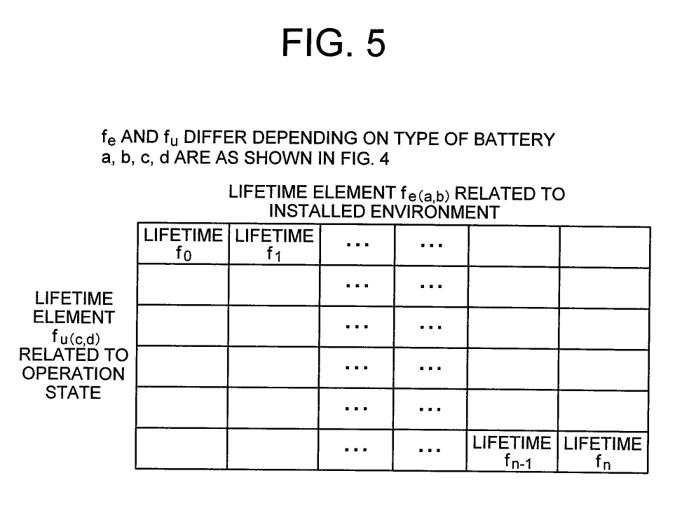

The microprocessor 10 serving as the lifetime calculating device then obtains the lifetime fᵢ of the battery backup unit 9, specifically, the replacement time of the battery backup unit 9 from the lifetime matrix shown in FIG. 5 (lifetime fᵢ is a value of the lifetime at where [row, column] is stored at a cell of a [fᵤ (c, d), fₑ (a, b)] spot in the lifetime matrix of FIG. 5), by taking into consideration the computation result of the lifetime element calculated by the environment reference lifetime element calculating device, that is, the function fₑ (a, b), and the computation result of the lifetime element fᵤ (c, d) calculated by the operation reference lifetime element calculating device; and the microprocessor 10 serving as the communication control device outputs the lifetime fᵢ, or the value of the replacement time, to the operation management server 6, which is a high-level device, via the interface 18 and the network 3 (step A11 of FIG. 3).

In this case, the lifetime determination by the battery backup unit 9 itself is carried out, similar to the case of the related art, based on the change in the charging amount or the charging required time of the battery backup unit 9 in addition to the lifetime determination using the matrix of FIG. 5, and the result thereof is also output to the operation management server 6.

The operation management server 6 displays the contents thereof to the attached display device etc., and stores the same as log. Various types of lifetime matrixes are stored in the ROM 14 in advance according to the type of battery incorporated in the battery backup unit 9, and the microprocessor 10 serving as the lifetime calculating device reads out the lifetime matrix corresponding to the type of battery from the ROM 14, and calculates the lifetime fi of the battery backup unit 9 in the process of step A11.

A case of transmitting information which indicates that the installed environment of the disc array device 1 is not appropriate or the operation state is not appropriate, the lifetime or the replacement period of the battery backup unit 9, and the like to the operation management server 6 and central managing the same has been described by way of example, but such information may be displayed on the display device of the operation management server 6, monitored by outputting the log in prints from the printer connected to the operation management server 6, or transferred to another computer terminal 4 by using e-mail, form, and the like from the operation management server 6 to be notified to the user.

Further, such information may be transmitted to the computer terminal 4 via the network 3 without passing the operation management server 6, or information may be transferred from the disc array device 1 to the high-level device via the interface 18 of the disc array device 1 and the interface on the high-level device side when directly connecting the high-level device and the disc array device 1 without using the network 3.

In order to output the installed environment and the operation state of the disc array device 1, and the lifetime of the battery backup unit 9 to the outside to notify the same to the user, some type of output equipment is required, but the configuration thereof may be of any form as long as information from the disc array device 1 can be received.

For instance, an inexpensive liquid crystal display device etc. may be attached to the disc array device 1 itself to notify the information to the user.

In other words, only the disc array device 1 is basically required to notify the lifetime of the battery backup unit 9 as well as the appropriateness of the installed environment and the operation state of the disc array device 1.

As described above, in the exemplary embodiment, the discharging interval “c” and the discharging depth “d”, which are operation state information reflecting the operation state, that is, the usage manner of the battery backup unit 9, are detected, and the lifetime element of the battery backup unit dependent on the operation state information is calculate with the function fᵤ (c, d) stored in the ROM 14, and furthermore, the average temperature “a” and the ratio “b” of the number of samplings related to appropriateness of the temperature detection value, which are installed environment information reflecting the installed environment of the battery backup unit 9, are obtained, and the lifetime element of the battery backup unit dependent on the installed environment information is calculated with the function fₑ (a, b) stored in the ROM 14, and finally, the lifetime fᵢ of the battery backup unit 9 is estimated from the lifetime matrix as shown in FIG. 5 by taking such lifetime elements into consideration, and thus the lifetime and the replacement period of the battery backup unit 9 can be accurately estimated, thereby preventing such disadvantages that the battery backup unit which is still in the usable state gets replaced at an early stage, or, the battery backup unit is continuously used beyond the durable limit and the reliability of the disc array device lowers, in advance.

Furthermore, in this exemplary embodiment, the user can easily recognize the abnormality of the operation state and the abnormality of the installed environment, since the abnormality of the operation state of the battery backup unit 9 and the abnormality of the installed environment are detected, and such information are notified to the user by being displayed on the display device etc. of the operation management server 6 and the computer terminal 4 along with the discharging interval “c” and the discharging depth “d”, and furthermore, the average temperature “a” and the ratio “b” of the number of samplings related to appropriateness of the temperature detection value.

In this case, the battery backup unit 9 can be operated efficiently by improving the operation state of the battery backup unit 9, for example the usage frequency and the usage time of the backup unit 9, to adjust the discharging interval “c” and the discharging depth “d”, or arranging the disc array device 1 at an appropriate place to prevent rise in temperature, at the determination of the user.

In the exemplary embodiment, the final lifetime fᵢ of the battery backup unit 9 is obtained by taking into consideration the value of the lifetime element obtained with the function fᵤ (c, d) dependent on the discharging “c” and the discharging depth “d”, which are one type of operation state information, and the value of the lifetime element obtained with the function fₑ (a, b) dependent on the average temperature “a” and the ratio “b” of the number of samplings, which are one type of installed environment information, but the lifetime of the battery backup unit 9 may be calculated based only on the value of the lifetime element obtained depending on the operation state information such as the discharging interval “c” and the discharging depth “d”

In this case, the microprocessor 10 of the disc controller 8 serves as the operation reference lifetime calculating device for calculating the lifetime of the battery backup unit 9 based only on the operation state information in the process of step A11. The lifetime matrix used in this case is not the matrix which stores data of a plurality of columns corresponding to the values of the lifetime element fₑ (a, b), but has a configuration of multiple rows and one column which is formed by retrieving data for one column from the lifetime matrix shown in FIG. 5, where the lifetime element dependent on the installed environment information is not reflected, and thus the accuracy in the prediction of the lifetime lowers compared to the case of the exemplary embodiment described above.

Another exemplary embodiment of the present invention will now be described. A disc array device according to a second exemplary embodiment of the present invention may be a disc array device including a disc unit for storing data; a disc controller for controlling input/output of data between the disc unit and the high-level device; and a battery backup unit for supplying backup power to the disc unit and the disc controller, and the device further includes an operation state detecting device for detecting an operation state of the battery backup unit, an operation reference lifetime calculating device for calculating a lifetime element of the battery backup unit based on the operation state detected by the operation state detecting device, an operation reference lifetime element calculating device for calculating a lifetime of the battery backup unit based on the lifetime element calculated by the operation reference lifetime element calculating device, and an interface for outputting the lifetime calculated by the operation reference lifetime calculating device to the outside.

The operation state detecting device is preferably configured to detect at least the discharging interval and the discharging depth of the battery backup unit as operation states of the battery backup unit.

The operation reference lifetime element calculating device calculates the lifetime element of the battery backup unit for each operation state information based on the operation state information such as discharging interval and discharging depth of the battery backup unit detected by the operation state detecting device.

Finally, the operation reference lifetime calculating device calculates the overall lifetime of the battery backup unit based on the lifetime element of the battery backup unit such as the lifetime element dependent on the discharging interval and the lifetime element dependent on the discharging depth for every operation state information calculated by the operation reference lifetime element calculating device, and notifies the lifetime to the user by being output to the outside via the interface.

A device to be used for notifying the lifetime may include a high-level device connected to the disc array device such as the display device etc. of the operation management server via the interface or the network, and also the operation management server which transfers the lifetime information to another computer terminal by using e-mail to notify to the user may be used.

With this, the discharging interval and the discharging depth, which are operation state information reflecting the operation state, that is, the usage manner of the battery backup unit, are detected, the lifetime element of the battery backup unit dependent on each operation state information is obtained, and the final lifetime of the battery backup unit is estimated by taking these lifetime elements into consideration, and thus the lifetime of the battery backup unit can be accurately estimated, and such disadvantages that the battery backup unit which is still in the usable state gets replaced at an early stage, or, the battery backup unit is continuously used beyond the durable limit and the reliability of the disc array device lowers are prevented in advance.

As a third exemplary embodiment, the operation state abnormality detecting device for detecting the abnormality of the operation state of the battery backup unit may be arranged, and a function for outputting the abnormality detected by the operation state abnormality detecting device to the outside may be given to the interface.

The operation state abnormality detecting device is desirably configured to detect the abnormality of at least the discharging interval and the discharging depth of the battery backup unit as abnormality of the operation state.

The abnormality of the operation state such as the abnormality of the discharging interval and the discharging depth of the battery backup unit detected by the operation state abnormality detecting device is notified to the user by being output to the outside via the interface, similar to the above.

A device to be used for notifying the abnormality of the operation state may include a high-level device connected to the disc array device such as the display device etc. of the operation management server via the interface or the network, and also the operation management server which transfers the lifetime information to another computer terminal by using e-mail to notify to the user may be used.

Since the abnormality of the operation state of the battery backup unit can be easily recognized, the battery backup unit can be efficiently operated by improving the operation state of the battery backup unit at the determination of the user.

As a fourth exemplary embodiment, an operation state detecting device for detecting an operation state of the battery backup unit; an installed environment detecting device for detecting the installed environment of the battery backup unit; an operation reference lifetime calculating device for calculating a lifetime element of the battery backup unit based on the operation state detected by the operation state detecting device; an environment reference lifetime element calculating device for calculating the lifetime element of the battery backup unit based on the installed environment detected by the installed environment detecting device; a lifetime calculating device for calculating a lifetime element calculated by the operation reference lifetime element calculating device and the lifetime element calculated by the environment reference lifetime element calculating device, and an interface for outputting the lifetime calculated by the lifetime calculating device to the outside may be arranged.

The installed environment detecting device is desirably configured to detect at least the temperature of the battery backup unit as the installed environment of the battery backup unit.

The environment reference lifetime element calculating device calculates the lifetime of the battery backup unit for each installed environment information based on the installed environment information such as temperature of the battery backup unit detected by the installed environment detecting device.

Finally, the lifetime calculating device calculates the overall lifetime of the battery backup unit based on the lifetime element of the battery backup unit such as the lifetime element dependent on the discharging interval and the lifetime element dependent on the discharging depth for every operation state information calculated by the operation reference lifetime element calculating device, and the lifetime element of the battery backup unit such as the lifetime element dependent on the temperature of the battery backup unit for every installed environment information calculated by the environment reference lifetime element calculating device, and notifies the lifetime to the user by outputting to the outside via the interface.

A device to be used for notifying the lifetime may include a high-level device connected to the disc array device such as the display device etc. of the operation management server via the interface or the network, and also the operation management server which transfers the lifetime information to another computer terminal by using e-mail to notify to the user may be used.

With this, in addition to the lifetime element of the battery backup unit dependent on the operation state information reflecting the operation state of the battery backup unit, the lifetime element of the battery backup unit dependent on the installed environment information reflecting the installed environment of the battery backup unit is obtained and the final lifetime of the battery backup unit is estimated by taking these lifetime elements into consideration, and thus the lifetime of the battery backup unit can be accurately estimated, and such disadvantages that the battery backup unit which is still in the usable state gets replaced at an early stage, or, the battery backup unit is continuously used beyond the durable limit and the reliability of the disc array device lowers are prevented in advance.

Further, as a fifth exemplary embodiment, the operation state abnormality detecting device for detecting the abnormality of the operation state of the battery backup unit and an installed environment abnormality detecting device for detecting the abnormality of the installed environment of the battery backup unit may be adjacently arranged, and a function for outputting the abnormality detected by the operation state abnormality detecting device and the installed environment abnormality detecting device to the outside may be given to the interface.

The installed environment abnormality detecting device is desirably configured to detect the abnormality related to at least the temperature of the battery backup unit as abnormality of the installed environment.

The abnormality of the operation state such as the abnormality of the discharging interval and the discharging depth of the battery backup unit detected by the operation state abnormality detecting device, and furthermore, the abnormality of the installed environment such as the abnormality related to the temperature of the battery backup unit detected by the installed environment abnormality detecting device are notified to the user by being output to the outside via the interface, similar to the above.

A device to be used for notifying the abnormality of the operation state and the installed environment may include a high-level device connected to the disc array device such as the display device etc. of the operation management server by way of the interface or the network, and also the operation management server which transfers the lifetime information to another computer terminal by using e-mail to notify to the user may be used.

With this, since the abnormality of the installed environment of the battery backup unit can be easily recognized in addition to the abnormality of the operation state of the battery backup unit, the battery backup unit can be efficiently operated by improving the operation state of the battery backup unit and the installed environment at the determination of the user.

A disc controller control program according to a sixth exemplary embodiment of the invention is configured to cause a microprocessor arranged in a disc controller of the disc array device to serve as an operation state detecting device for detecting the operation state of the battery backup unit, an operation reference lifetime element calculating device for calculating the lifetime element of the battery backup unit based on the operation state detected by the operation state detecting device, an operation reference lifetime calculating device for calculating the lifetime of the battery backup unit based on the lifetime element calculated by the operation reference lifetime element calculating device, and a communication control device for outputting the lifetime calculated by the operation reference lifetime calculating device to the outside.

The microprocessor controlled by the disc controller control program serves as the operation state detecting device, the operation reference lifetime element calculating device, and the operation reference lifetime calculating device, and also serves as the communication control device for outputting the lifetime calculated by the operation reference lifetime calculating device to the outside via the interface of the disc array device.

As a seventh exemplary embodiment, the disc controller control program may be configured to cause the microprocessor arranged in the disc controller to serves as an operation state abnormality detecting device for detecting the abnormality of the operation state of the battery backup unit, and to serves as a communication control device for outputting the lifetime calculated by the operation reference lifetime calculating device and the abnormality detected by the operation state abnormality detecting device to the outside.

In this case, the microprocessor controlled by the disc controller control program serves as the operation state detecting device, the operation state abnormality detecting device, the operation reference lifetime element calculating device, and the operation reference lifetime calculating device, and also serves as the communication control device for outputting the lifetime calculated by the operation reference lifetime calculating device and the abnormality detected by the operation state abnormality detecting device to the outside via the interface of the disc array device.

As an eighth exemplary embodiment, the controller control program may be configured to cause the microprocessor arranged in a disc controller to serve as an installed environment detecting device for detecting the installed environment of the battery backup unit, an environment reference lifetime element calculating device for calculating the lifetime element of the battery backup unit based on the installed environment detected by the installed environment detecting device, a lifetime calculating device for calculating the lifetime of the battery backup unit based on the lifetime element calculated by the operation reference lifetime element calculating device and the lifetime element calculated by the environment reference lifetime element calculating device, and a communication control device for outputting the lifetime calculated by the lifetime calculating device to the outside.

When such configuration is applied, the microprocessor controlled by the disc controller control program serves as the operation state detecting device, the installed environment detecting device, the operation reference lifetime element calculating device, the environment reference lifetime element calculating device, and the lifetime calculating device, and also serves as the communication control device for outputting the lifetime calculated by the lifetime calculating device to the outside via the interface of the disc array device.

As a ninth exemplary embodiment, the disc controller control program may be configured to further cause a microprocessor arranged in a disc controller to serve as an operation state abnormality detecting device for detecting the abnormality of the operation state of the battery backup unit, an installed environment abnormality detecting device for detecting the abnormality of the installed environment of the battery backup unit, and a communication control device for outputting the lifetime calculated by the lifetime calculating device, the abnormality detected by the operation state abnormality detecting device, and the abnormality detected by the installed environment abnormality detecting device to the outside.

In this case, the microprocessor controlled by the disc controller control program serves as the operation state detecting device, the installed environment detecting device, the operation state abnormality detecting device, the installed environment abnormality detecting device, the operation reference lifetime element calculating device, the environment reference lifetime element calculating device, and the lifetime calculating device, and also serves as the communication control device for outputting the lifetime calculated by the lifetime calculating device, the abnormality detected by the operation state abnormality detecting device, and the abnormality detected by the installed environment abnormality detecting device to the outside via the interface of the disc array device.

Similar to the above, specifically, the operation state detecting device detects the discharging interval, the discharging depth, and the like of the battery backup unit as operation state information of the battery backup unit, the operation state abnormality detecting device detects abnormality etc. of the discharging interval and he discharging depth of the battery backup unit as abnormality of the operation state, the installed environment detecting device detects temperature etc. of the battery backup unit as installed environment information of the battery backup unit, and the installed environment abnormality detecting device detects abnormality etc. related to the temperature of he battery backup unit as abnormality of the installed environment.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A disc array device comprising: a disc unit which stores data, a disc controller which controls input/output of data between the disc unit and a high-level device, and a battery backup unit which supplies backup power to the disc unit and the disc controller; the disc array device comprising:
an operation state detecting device which detects an operation state of the battery backup unit;
an operation reference lifetime element calculating device which calculates a lifetime element of the battery backup unit based on the operation state detected by the operation state detecting device; and
an operation reference lifetime calculating device which calculates a lifetime of the battery backup unit based on the lifetime element calculated by the operation reference lifetime element calculating device.

2. The disc array device according to claim 1, wherein an operation state abnormality detecting device which detects an abnormality of the operation state of the battery backup unit is arranged.

3. The disc array device according to claim 1, further comprising:
an installed environment detecting device which detects an installed environment of the battery backup unit;
an environment reference lifetime element calculating device which calculates a lifetime element of the battery backup unit based on the installed environment detected by the installed environment detecting device;
a lifetime calculating device which calculates the lifetime of the battery backup unit based on the lifetime element calculated by the operation reference lifetime element calculating device and the lifetime element calculated by the environment reference lifetime element calculating device; and
an interface which outputs the lifetime calculated by the lifetime calculating device to the outside.

4. The disc array device according to claim 3, wherein an operation state abnormality detecting device which detects an abnormality of the operation state of the battery backup unit and an installed environment abnormality detecting device which detects an abnormality of the installed environment of the battery backup unit are arranged.

5. The disc array device according to claim 4, wherein
the operation state abnormality detecting device detects at least a discharging interval and a discharging depth of the battery backup unit as the operation state;
the installed environment detecting device detects at least a temperature of the battery backup unit as the installed environment;
the operation state abnormality detecting device detects the abnormality of at least the discharging interval and the discharging depth of the battery backup unit as abnormality of the operation state; and
the installed environment abnormality detecting device detects abnormality related to at least the temperature of the battery backup unit as abnormality of the installed environment.

6. A disc array device comprising: a disc unit for storing data, a disc controller for controlling input/output of data between the disc unit and a high-level device, and a battery backup unit for supplying backup power to the disc unit and the disc controller; the disc array device comprising:
an operation state detecting means for detecting an operation state of the battery backup unit;
an operation reference lifetime element calculating means for calculating a lifetime element of the battery backup unit based on the operation state detected by the operation state detecting means; and
an operation reference lifetime calculating means for calculating a lifetime of the battery backup unit based on the lifetime element calculated by the operation reference lifetime element calculating means.

7. A battery backup drive controlling method for supplying a backup power by drive controlling a battery backup unit; the method comprising:
detecting an operation state of the battery backup unit;
calculating a lifetime element of the battery backup unit based on the detected operation state; and
calculating a lifetime of the battery backup unit based on the calculated lifetime element.

8. The battery backup drive controlling method according to claim 7, further comprising detecting an abnormality of the operation state of the battery backup unit.

9. The battery backup drive controlling method according to claim 7, further comprising:
detecting an installed environment of the battery backup unit;
calculating a lifetime element of the battery backup unit based on the detected installed environment; and
calculating a lifetime of the battery backup unit based on the calculated lifetime element.

10. The battery backup drive controlling method according to claim 9, further comprising detecting an abnormality of the operation state of the battery backup unit, and detecting an abnormality of the installed environment of the battery backup unit.

11. The battery backup drive controlling method according to claim 9, further comprising:
detecting at least a discharging interval and a discharging depth of the battery backup unit as the operation state;
detecting at least a temperature of the battery backup unit as the installed environment;
detecting the abnormality of at least the discharging interval and the discharging depth of the battery backup unit as abnormality of the operation state; and
detecting the abnormality related to at least the temperature of the battery backup unit as abnormality of the installed environment.

12. A disc controller control program for causing a microprocessor arranged in a disc controller of a disc array device to execute functions of:
detecting an operation state of the battery backup unit;
calculating a lifetime element of the battery backup unit based on the detected operation state; and
calculating a lifetime of the battery backup unit based on the calculated lifetime element.

13. The disc controller control program according to claim 12, for causing the microprocessor to execute a function of detecting an abnormality of the operation state of the battery backup unit.

14. The disc controller control program according to claim 12, for causing the microprocessor to execute functions of:
detecting an installed environment of the battery backup unit;
calculating a lifetime element of the battery backup unit based on the detected installed environment; and
calculating a lifetime of the battery backup unit based on the calculated lifetime element.

15. The disc controller control program according to claim 14, for causing the microprocessor to execute functions of detecting an abnormality of the operation state of the battery backup unit, and detecting an abnormality of the installed environment of the battery backup unit.

16. The disc controller control program according to claim 14, for causing the microprocessor to execute functions of:
detecting at least a discharging interval and a discharging depth of the battery backup unit as the operation state;
detecting at least a temperature of the battery backup unit as the installed environment;
detecting the abnormality of at least the discharging interval and the discharging depth of the battery backup unit as abnormality of the operation state; and
detecting the abnormality related to at least the temperature of the battery backup unit as abnormality of the installed environment.
